(19) United States
(12) Patent Application Publication
(10) Pub. No.: US 2021/0182183 A1
(43) Pub. Date: Jun. 17, 2021

(54) Enhanced Performance Testing Script Conversion

(71) Applicant: SAP SE, Walldorf (DE)

(72) Inventor: Deng Feng Wan, Shanghai (CN)

(21) Appl. No.: 16/711,326

(22) Filed: Dec. 11, 2019

(51) Int. Cl. G06F 11/36; H04L 29/08

(52) U.S. Cl. CPC G06F 11/3688; H04L 67/02; G06F 11/3696; G06F 11/3664

(57) ABSTRACT

Testing script files are received including a load test scenario file, a parameters file, and action file. These testing script files are all in a first programming language compatible with a first testing application and are collectively used to simulate actions of a large number of users interacting with a cloud-based application. Subsequently, each of the load test scenario file, the parameters file, and the action file are individually parsed to extract data therefrom. This extracted data is then used to populate an object. The data in this object is then converted to a converted testing script in a second programming language compatible with a second testing application. Related apparatus, systems, techniques and articles are also described.

### TECHNICAL FIELD

The subject matter described herein relates to enhanced techniques for converting testing scripts from a first, more computationally expensive protocol to a second, less computationally expensive protocol.

### BACKGROUND

As more companies are providing complex, cloud-based applications, performance testing becomes increasingly important to ensure fast and continuous delivery to users. In particular, Hyptertext Transfer Protocol (HTTP) performance testing can be used to characterize the performance of applications when large number of users (e.g., thousands, etc.) are concurrently executing such applications. Such testing can mimic messages between application components or by simulating interactions with graphical user interface elements which, in turn, can be derived from actual user activities.

Some performance testing applications, including those that execute C-based scripts, are computationally intensive. For example, one performance testing application might need as many as one agent WINDOWS machine for each two thousand users. Given such a requirement, scalability is also difficult making it more difficult to model real world situations having large scales of users.

### SUMMARY

In a first aspect, testing script files are received including a load test scenario file, a parameters file, and action file. These testing script files are all in a first programming language compatible with a first testing application and are collectively used to simulate actions of a large number of users interacting with a cloud-based application. Subsequently, each of the load test scenario file, the parameters file, and the action file are individually parsed to extract data therefrom. This extracted data is then used to populate an object. The data in this object is then converted to a converted testing script in a second programming language compatible with a second testing application.

The first programming language can be C and/or the second programming language can be SCALA. The object can be a JAVA object (e.g., JSON). In some variations, the received testing script files can be compatible with the LOADRUNNER testing framework and the converted testing script can be compatible with the GATLING testing framework.

After the conversion, testing of the cloud-based application can be initiated by the second testing application using the data converted in the object in the second programming language.

The parsing can include parsing at least a portion of received testing script files to obtain individual Hypertext Transfer Protocol (HTTP) requests, parsing each HTTP request to obtain a corresponding HTTP header, a HTTP body and HTTP parameter details.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter provides enhanced techniques for converting performance testing scripts adapted to computationally expensive protocols to less computationally expensive protocols. Such a conversion allows for more efficient performance testing which, while at the same time, is more scalable to more readily mimic real-world, large-scale testing conditions.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a first process flow diagram illustrating conversion of testing scripts files from a first computer language compatible with a first testing application to a second computer language compatible with a second testing application;

FIG. 2 is a process flow diagram illustrating the parsing of a load testing scenario file (eg: .lrs file);

FIG. 3 is a process flow diagram illustrating the parsing of a parameters file (eg: .prm file);

FIG. 4 is a first process flow diagram illustrating the parsing of an action file (eg: .c file);

FIG. 5 is a second process flow diagram illustrating the parsing of the action file;

FIG. 6 is a second process flow diagram illustrating conversion of testing scripts files from a first computer language compatible with a first testing application to a second computer language compatible with a second testing application; and

FIG. 7 is a diagram illustrating a sample computing device for implementing aspects of the current subject matter.

### DETAILED DESCRIPTION

The current subject matter is directed to converting HTTP performance testing scripts from a first language to a second language which, in turn, allows for the more computationally efficient testing that more closely mimics real-world applications in which there are thousands of concurrent users. Such a conversion can be helpful, in particular, to automatically convert complex legacy scripts. While the current subject matter, as an example, is directed to the conversion of testing scripts in the C programming language to testing scripts in the SCALA programming language, it will be appreciated that the current subject matter can also be applied to converting testing scripts in and to other programming languages. Further, while the current subject matter is directed to the conversion of testing scripts compatible with the LOADRUNNER software application to the open source GATLING software application,

The performance testing scripts are often based on or otherwise derived from monitored/logged user actions (which are recorded therein). Once the testing scripts are generated, they can be replayed so that they can be verified as working properly and/or impact on the applications can be determined. In certain cases, the testing scripts can be enhanced by adding checkpoints, validating data, adding transactions, and rendezvous points. Various runtime settings can also be configured as well as testing scenarios (e.g., load stress testing, etc.).

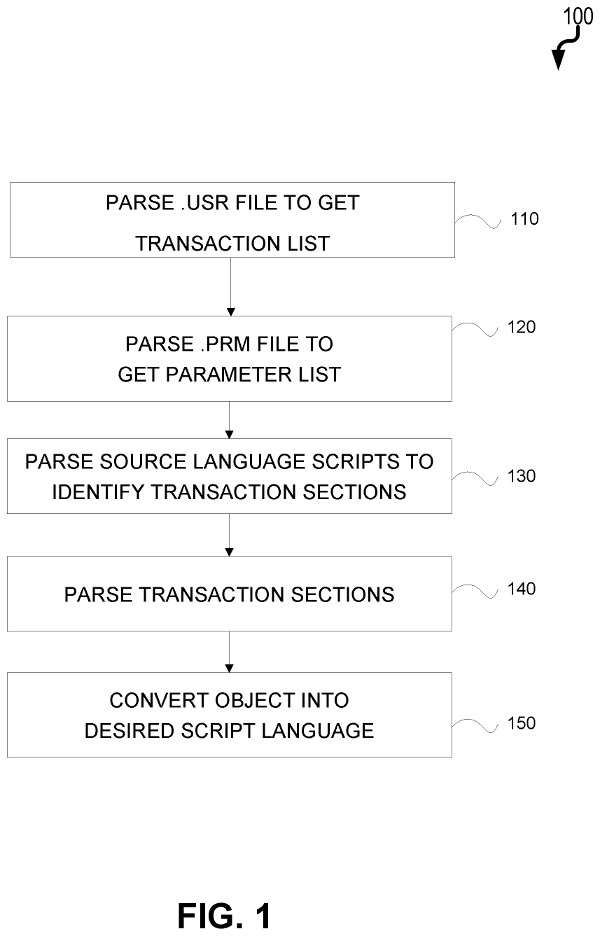

With reference to diagram 100 of FIG. 1, initially, at 110, a .usr file (which stores a transaction list and a related parameter file list) is parsed to get a transactions list/prm file list. A transaction is an end-to-end measurement of a user action (or a group of user actions) on an application. Transactions can be inserted during recording or subsequently (through a manual insertion). Thereafter, at 120, the .prm file is parsed to get a parameter list and parameter detailed information which define which values will be passed to the application being tested as part of the transaction. Next, at 130, the source language (e.g., C language) scripts are parsed by reading the corresponding text file as a string and the dividing the string into different transaction sections. The different transaction sections are then parsed, at 140, into different HTTP request which, in turn, are each parsed to obtain information such as HTTP header, HTTP body and HTTP parameter details. Such parsed information can then be used to populate a data object such as a JSON object. Lastly, at 150, using a pre-defined mapping, the data in the JSON object is read through and then converted into a SCALA script (e.g., a GAITLING SCALA script, etc.).

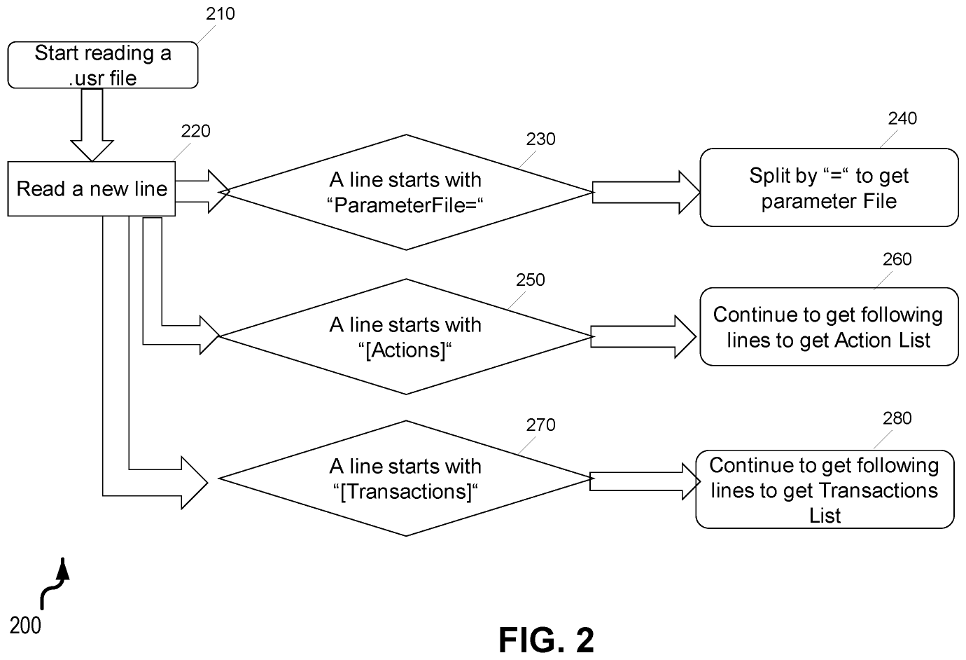

FIG. 2 is a process flow diagram 200 illustrating further details regarding the parsing of a .usr file (as in 110). Initially, at 210, a .usr file is read. Thereafter, at 210, each line within the file is iterated through. If it is determined, at 220, that each line starts with a parameter indicator (e.g., ParameterFile=), then, at 230, the line can be split to get a parameter file (e.g., split at “=”). If it is determined, at 240, that each line starts with an action indicator (e.g., [Actions]), then, at 250, additional, related lines can be obtained to get an action list. If it is determined, at 260, that each line starts with a transaction indicator (e.g., [Transactions]), then, at 270, additional, related lines can be obtained to get a transaction list.

Below is example code for implementing the process illustrated in FIG. 2:

while (readLine != null) {

if readline contains ″[Actions]” {

readActionsFlag = true;

} else if readline meet next “[“ tag {

readActionsFlag = false;

} else {

if is readActionsFlag set to true, read this line and

store to Actions List.

}
if readline contains “ParameterFile=” {
get the part after “=“ to retrieve parameter File exact

name

}
if readline contains ″[Transactions]” {

readTransactionsFlag = true;

} else if readline meet next “[“ tag {

readTransactionsFlag = false;

} else {

if is readTransactionsFlag set to true, read this line

and store to Transaction List.

}

}

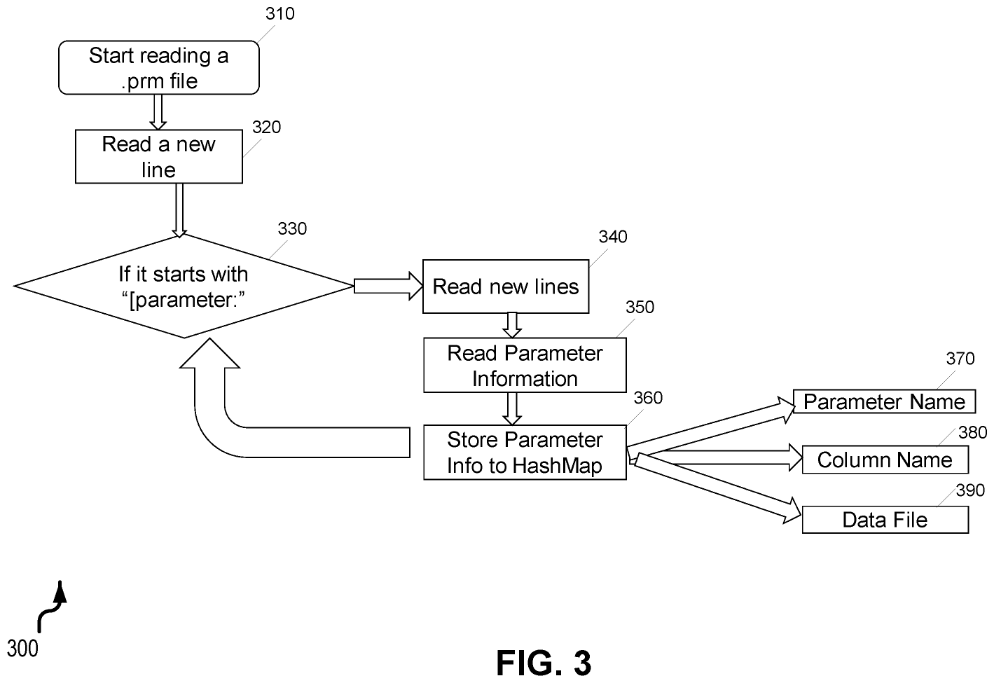

FIG. 3 is a process flow diagram 300 illustrating further details regarding the parsing of the .prm file (as in 120). Initially, at 310, a .prm file is accessed and, at 320, a first line in such file is read. If, at 330, the line starts with a parameter indicator (e.g., [parameter:), then, at 340, new lines are sequentially read (e.g., all lines of the .prm file are looped through) until a certain condition is met (e.g., a parameter definition is located, etc.). From these new lines, at 350, parameter information is read. This parameter information is then stored, at 360, to a hash map (e.g., parameter name 370, column name 380, data file 390). The process can continue, at 330, to iterate through more lines and extract parameter information to be added to the hash map.

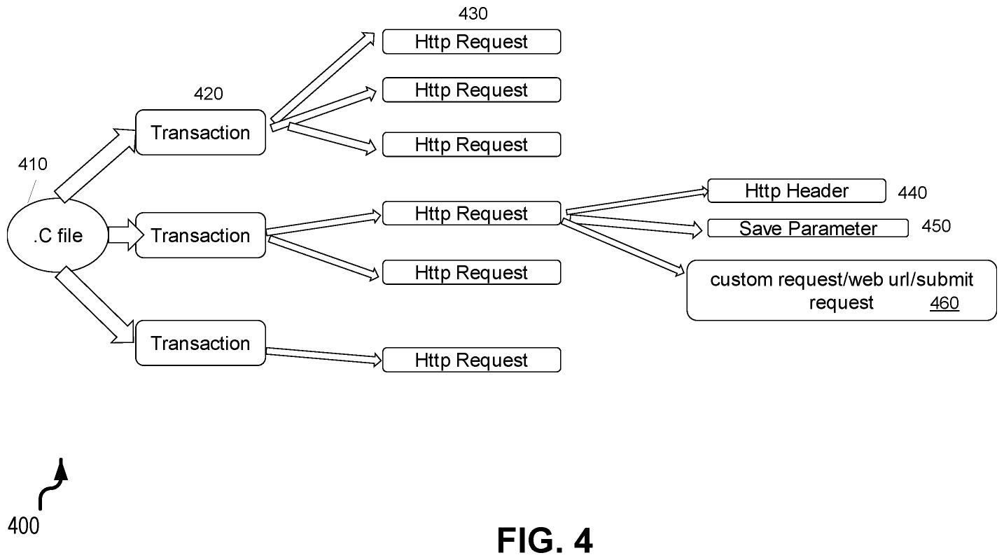

FIG. 4 is a first process flow diagram 400 illustrating further details regarding the parsing of the source language scripts (as in 130). At 410, a file (e.g., a file in C language) specifies a series of transactions 420. These transactions 420 each implicate a series of HTTP requests 430 which are designed to mimic certain user actions with the application (e.g., to simulate load testing under real world scenarios, etc.). Each HTTP request 430 can include data including a header 440, a save parameter 450, and a request 460 or information associated with a request such as URL and the like.

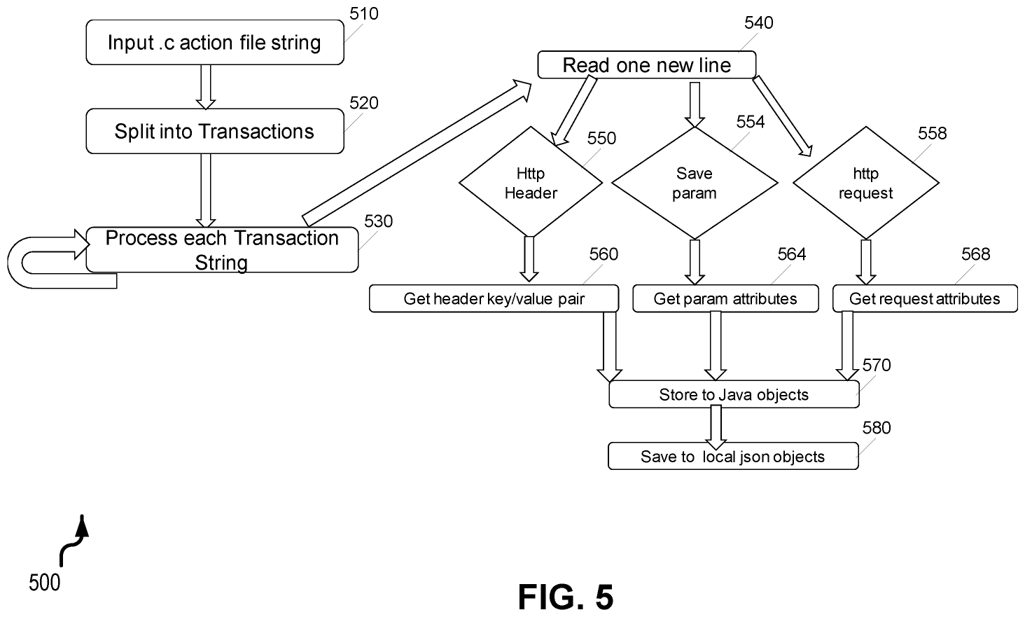

FIG. 5 is a second process flow diagram 500 illustrating further details regarding the parsing of the source language scripts (as in 130). Initially, at 510, a file action string (e.g., a C language action string) is inputted so, at 520, it can be split into various transaction strings. These process strings are then sequentially processed, at 530, by, at 540, iterating through each line. Such iteration can allow for information to be from portions of the strings such as header/key value pair 560 from the HTTP header, parameter attributes 564 from the save parameter portion 554, and HTTP request information 568 HTTP request from the HTTP request portion 558. This extracted information can be stored, at 570, to a JAVA object and, subsequently, at 580, to a local JSON object.

Table 1 below provides a mapping between JAVA objects and SCALA Scripts:

TABLE 1

| JAVA OBJECT | SCALA SCRIPT |
|---|---|
| User Data File | val datafile definition |
| transaction list | val scenario definition |
| action .C file | transaction object definition |
| transaction | var transaction definition |
| HTTP request | HTTP get or post |
| HTTP header | header properties |
| HTTP parameter | form parameter |
| saveAs parameter | Regex saveAs param |

The information obtained as provided above can be used to convert the performance testing scripts from the first language to performance testing scripts in the second computer language. Following the example above, SCALA scenario testing scripts can be generated from .usr and .prm files. An empty StringBuilder (JAVA StringBuilder was used to concatenate many strings. Here the StringBuilder can be used to append all contents which would be the target SCALA scripts string) is generated to which certain information can be appended including package information, import packages, class definition(s) for the scenario, user data definition val, transaction list definition(s) (HTTP request definition, HTTP header definition, HTTP request param definition, HTTP request form data definition, etc.), and/or an injection definition. As an example, JAVA StringBuilder can be used to concatenate many strings including the target SCALA scripts strings.

The action .C file can be converted into a SCALA transaction script in a similar manner. For example, an empty string builder can be used to concatenate information including package information, import packages, object definition(s) of the transactions, transaction list definition(s) (HTTP request definition, HTTP header definition, HTTP request param definition, HTTP request form data definition, etc.), and/or tail of object definition.

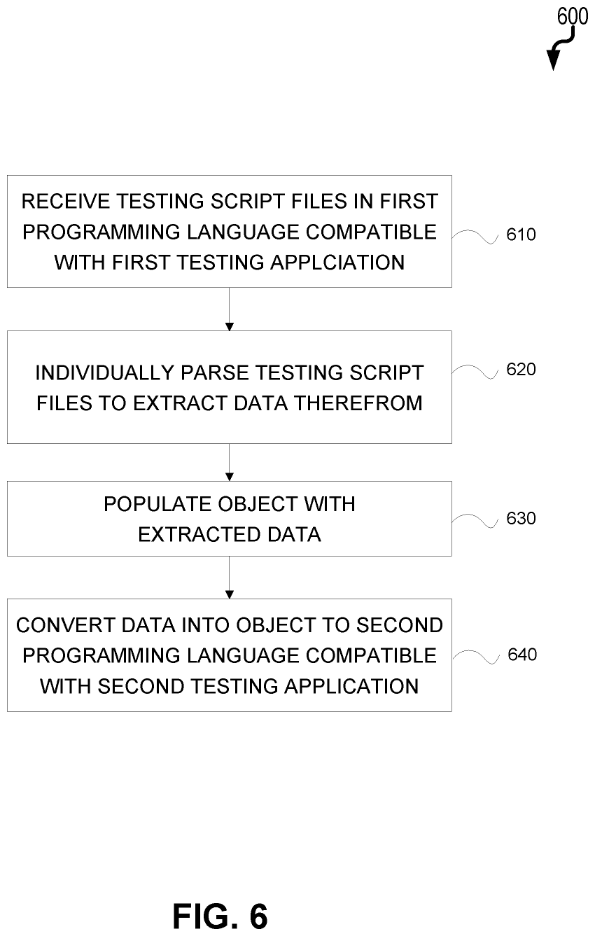

FIG. 6 is a process flow diagram 600 in which, at 610, testing script files are received including a load test scenario file, a parameters file, and action file. Such files are all in a first programming language compatible with a first testing application. The testing script files are collectively used to simulate actions of a large number of users interacting with a cloud-based application. Subsequently, at 620, each of the load test scenario file, the parameters file, and the action file are parsed to extract data therefrom. Next, at 630, an object is populated with the data extracted as part of the parsing. The data in the object is then converted, at 640, to a second programming language compatible with a second testing application. This converted information is then used (either directly or with further processing) as a testing script for the second testing application.

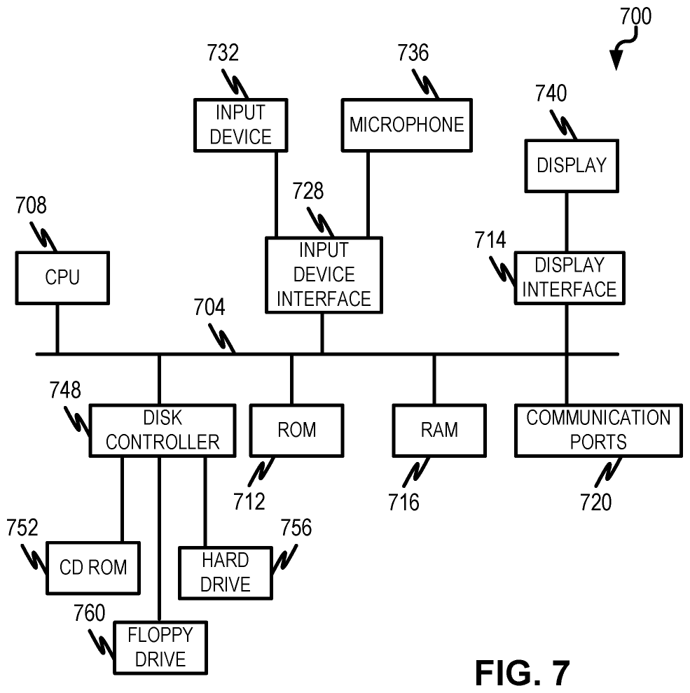

FIG. 7 is a diagram 700 illustrating a sample computing device architecture for implementing various aspects described herein. A bus 704 can serve as the information highway interconnecting the other illustrated components of the hardware. A processing system 708 labeled CPU (central processing unit) (e.g., one or more computer processors/data processors at a given computer or at multiple computers), can perform calculations and logic operations required to execute a program. A non-transitory processor-readable storage medium, such as read only memory (ROM) 712 and random access memory (RAM) 716, can be in communication with the processing system 708 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 748 can interface with one or more optional disk drives to the system bus 704. These disk drives can be external or internal floppy disk drives such as 760, external or internal CD-ROM, CD-R, CD-RW or DVD, or solid state drives such as 752, or external or internal hard drives 756. As indicated previously, these various disk drives 752, 756, 760 and disk controllers are optional devices. The system bus 704 can also include at least one communication port 720 to allow for communication with external devices either physically connected to the computing system or available externally through a wired or wireless network. In some cases, the at least one communication port 720 includes or otherwise comprises a network interface.

To provide for interaction with a user, the subject matter described herein can be implemented on a computing device having a display device 740 (e.g., a CRT (cathode ray tube) or LCD (liquid crystal display) monitor) for displaying information obtained from the bus 704 via a display interface 714 to the user and an input device 732 such as keyboard and/or a pointing device (e.g., a mouse or a trackball) and/or a touchscreen by which the user can provide input to the computer. Other kinds of input devices 732 can be used to provide for interaction with a user as well; for example, feedback provided to the user can be any form of sensory feedback (e.g., visual feedback, auditory feedback by way of a microphone 736, or tactile feedback); and input from the user can be received in any form, including acoustic, speech, or tactile input. The input device 732 and the microphone 736 can be coupled to and convey information via the bus 704 by way of an input device interface 728. Other computing devices, such as dedicated servers, can omit one or more of the display 740 and display interface 714, the input device 732, the microphone 736, and input device interface 728.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer-implemented method comprising:
receiving testing script files comprising a load test scenario file, a parameters file, and action file, all in a first programming language compatible with a first testing application, the testing script files being collectively used to simulate actions of a large number of users interacting with a cloud-based application;
individually parsing each of the load test scenario file, the parameters file, and the action file to extract data therefrom;
populating an object with the data extracted as part of the parsing of each of the load test scenario file, the parameters file, and the action file; and
converting the data in the object to a converted testing script in a second programming language compatible with a second testing application.

2. The method of claim 1, wherein the first programming language is C.

3. The method of claim 2, wherein the second programming language is SCALA.

4. The method of claim 1, wherein the object is a JAVA object.

5. The method of claim 4, wherein the received testing script files are compatible with the LOADRUNNER testing framework and the converted testing script is compatible with the GATLING testing framework.

6. The method of claim 1 further comprising: initiating testing of the cloud-based application by the second testing application using the data converted in the object in the second programming language.

7. The method of claim 1, wherein the parsing comprises parsing at least a portion of received testing script files to obtain individual Hypertext Transfer Protocol (HTTP) requests, parsing each HTTP request to obtain a corresponding HTTP header, a HTTP body and HTTP parameter details.

8. A system comprising:
at least one data processor; and
memory storing instructions which, when executed by the at least one data processor, result in operations comprising:
receiving testing script files comprising a load test scenario file, a parameters file, and action file, all in a first programming language compatible with a first testing application, the testing script files being collectively used to simulate actions of a large number of users interacting with a cloud-based application;
individually parsing each of the load test scenario file, the parameters file, and the action file to extract data therefrom;
populating an object with the data extracted as part of the parsing of each of the load test scenario file, the parameters file, and the action file; and
converting the data in the object to a converted testing script in a second programming language compatible with a second testing application.

9. The system of claim 8, wherein the first programming language is C.

10. The system of claim 9, wherein the second programming language is SCALA.

11. The system of claim 10, wherein the object is a JAVA object.

12. The system of claim 11, wherein the received testing script files are compatible with the LOADRUNNER testing framework and the converted testing script is compatible with the GATLING testing framework.

13. The system of claim 10, wherein the operations further comprise:
initiating testing of the cloud-based application by the second testing application using the data converted in the object in the second programming language.

14. The system of claim 8, wherein the parsing comprises parsing at least a portion of received testing script files to obtain individual Hypertext Transfer Protocol (HTTP) requests, parsing each HTTP request to obtain a corresponding HTTP header, a HTTP body and HTTP parameter details.

15. A non-transitory computer program product storing instructions which, when executed by at least one computing device, result in operations comprising:
receiving testing script files comprising a load test scenario file, a parameters file, and action file, all in a first programming language compatible with a first testing application, the testing script files being collectively used to simulate actions of a large number of users interacting with a cloud-based application;
individually parsing each of the load test scenario file, the parameters file, and the action file to extract data therefrom by (i) parsing each such file to obtain individual Hypertext Transfer Protocol (HTTP) requests and (ii) parsing each HTTP request to obtain a corresponding HTTP header, a HTTP body and HTTP parameter details;
populating an object with the data extracted as part of the parsing of each of the load test scenario file, the parameters file, and the action file; and
converting solely the data in the object to a converted testing script in a second programming language compatible with a second testing application.

16. The computer product of claim 15, wherein the first programming language is C.

17. The computer product of claim 16, wherein the second programming language is SCALA.

18. The computer product of claim 17, wherein the object is a JAVA object.

19. The computer product of claim 18, wherein the received testing script files are compatible with the LOADRUNNER testing framework and the converted testing script is compatible with the GATLING testing framework.

20. The computer product of claim 15, wherein the operations further comprise:
initiating testing of the cloud-based application by the second testing application using the data converted in the object in the second programming language.
